(19) United States
(12) Patent Application Publication
(10) Pub. No.: US 2026/0194214 A1
(43) Pub. Date: Jul. 9, 2026

(54) A COLLAR FOR A RECESSED FIXTURE

(71) Applicant: Danny SMITH, Gosport, Hampshire (GB)

(72) Inventor: Danny SMITH, Gosport, Hampshire (GB)

(21) Appl. No.: 19/129,706

(22) PCT Filed: Nov. 14, 2023
(86) PCT No.: PCT/GB2023/052989

§ 371 Date: May 14, 2025

(30) Foreign Application Priority Data
Nov. 14, 2022 (GB) 2216983.3

(51) Int. Cl. F21V 21/04; F21S 8/02; F21V 15/01

(52) U.S. Cl. CPC F21V 21/047; F21S 8/026; F21V 15/01; F21V 21/049

(57) ABSTRACT

There is described a fitting system for a recessed fixture, in particular a recessed fixture for recessing in a hole. The fitting system comprises a collar having a wall to extend into the hole, such wall comprising an external formation for engaging with the hole, and one or more internal formations for engaging with one or more respective complementary formations on an exterior surface of the fixture or of a sleeve surrounding the fixture. In this way, a recessed fixture may be supplied without sprung arms (or if already fitted, the sprung arms may be removed). This removes the various problems (injury and damage to the ceiling) which may stem from the use of sprung arms. Instead, a collar is used to engage with on the one hand, the hole into which the fixture is to be installed (via the external formations), and with on the other hand the fixture itself (via the internal formation(s)).

### FIELD OF THE INVENTION

The present invention relates to a collar for a recessed fixture, an electric or electronic fixture recessed for example in a hole in a ceiling or similar; and/or a fixture comprising the collar. Embodiments of the present invention further relate to a method of installing (or partially installing) and/or removing (or partially removing) a recessed fixture using the collar.

### BACKGROUND

Increasing use of electrics and electronics is common to many societies. Many electrics and electronics may need to be recessed, into walls, ceiling, in holes.

Fixtures such as downlights, speakers or (passive infra-red) PIR sensors that have spring recess retaining arms may be retained by such sprung arms in a recess during use.

When installing or removing such fixtures it has become the practice to rely on the installation/removal person or user to try and hold the sprung arms up vertically against the downlight body while inserting or removing the downlight body through a hole, so the tension/force of sprung arms, do not allow the arms to spring down. The reliance on manually holding the arms up often results in injuring the user's fingers or damaging the recess surface. When installing the downlight body, once the downlight has been inserted far enough that the sprung arms must be released, the spring arms immediately and rapidly snap down to engage the ceiling, causing the downlight to be pulled violently up into the ceiling, potentially causing damage. When removing the downlight body, the sprung arms may cause damage to the edges of the hole until the downlight body is removed sufficiently that the sprung arms can be reached by hand.

The present invention arose in order to overcome problems suffered by existing devices.

### SUMMARY OF THE INVENTION

Various aspects and features of the present invention are defined in the claims.

According to one aspect of the present invention, there is provided a fitting system for a recessed fixture, in particular a recessed fixture for recessing in a hole, wherein the fitting system comprises a collar having a wall to extend into the hole, such wall comprising an external formation for engaging with the hole, and one or more internal formations for engaging with one or more respective formations on an exterior surface of the fixture or of a sleeve surrounding the fixture.

In this way, a recessed fixture may be supplied without sprung arms (or if already fitted, the sprung arms may be removed). This removes the problems identified above, which stem from the use of sprung arms. Instead, a collar is used to engage with on the one hand, the hole into which the fixture is to be installed (via the external formations), and with on the other hand the fixture itself (via the internal formation(s)).

The fitting system may comprise a sleeve for surrounding the fixture, the sleeve comprising the complementary formations, and one or more further complementary formations for engaging with the fixture. In this way, existing fixtures may be retrofitted with a sleeve to enable them to be mounted using the collar. In one example, the further complementary formations (of the sleeve) are shaped and dimensioned to engage with openings in the casing of the fixture from which sprung arms have been removed In this way, the problematic sprung arms of existing fixtures may be removed, and the openings they are removed from may be usefully utilised to permit the fixture to be retrofitted with mounting features (to mount to the collar) using the sleeve.

The further formations may be positioned on the sleeve such that the collar is retained proximate a light emitting end of the fixture. This enables the resulting fixture and sleeve combination to be secured to the collar proximate the ceiling.

As an alternative to the (retrofitted) arrangement utilising a sleeve, the fixture itself may comprise a housing having an external surface bearing the formations, wherein a plurality of such formations are provided-one each for engagement with the respective formations disposed on the collar.

In either case, the internal formations may comprise protrusions, and the complementary formations may comprise channels for receiving the protrusions.

The channels may each comprise a first channel part extending from one end of the wall for receiving the protrusions as the fixture is inserted into the collar, and a second channel part extending at an angle (for example substantially a right angle) to the first channel part, along which the protrusions pass as the fixture is secured into the collar.

The protrusions may be ramp, or wedge shaped, the ramp shape being (generally) complementary in shape with at least an end portion of the second channel part. Preferably though, the ramp shape of the protrusions has a larger angle than the shape or inclination of the second channel part, so that the stud become (removably) jammed in the channel upon rotation thereof.

The internal formations of the collar and the respective external formations (of the sleeve or fixture) may be configured to permit the internal and external formations to be fully engaged with each other by rotation of the fixture (and sleeve if present) and the collar with respect to each other.

The external formation of the wall of the collar may comprise screw threading for screwing the collar into the hole. However, it will appreciate that other formations, such as clips, gripping formations and the like, could be used instead. In the case that screw-threading is used, a direction of rotation of the collar to screw it into the hole and a direction of rotation of the fixture to secure it into the collar are preferably the same. In this way, when the fixture is screwed into the collar, this will cause the collar to more tightly grip the hole.

Preferably, the collar comprises a lip extending from the bottom edge of the wall.

The collar preferably comprises intumescent and/or fire retardant material.

The screw threading preferably comprises a sharp leading edge for cutting into the material around the edges of the hole through which the collar is being inserted.

The collar may further comprise one or more engagement formations for engaging with a tool. The engagement formations may comprise engagement slots within the inner surface of the wall of the collar.

According to another aspect of the invention, there is provide a device comprising a collar as described above, and a fixture.

According to another aspect of the invention, there is provided a method of fitting a recessed fixture into a hole, comprising inserting a collar having a wall into the hole, such that the wall enters the hole, rotating the collar within the hole such that an external formation on the wall engages with the hole, and inserting a fixture into the collar, such that one or more internal formations on the inside of the wall engage with one or more respective complementary formations on an exterior surface of the fixture or of a sleeve surrounding the fixture.

According to another aspect of the invention, there is provided a lighting assembly, comprising:
a housing;
a light generating unit;
a bezel; and
a securing ring;
wherein the bezel is securable to one end of the housing and the light generating unit is securable to the inside of the bezel; and
wherein the inside of the bezel comprises a formation for receiving the light generating unit, and the securing ring is configured to be mounted to the formation to secure the light generating unit to the bezel.

In this way, a simple structure is provided in which a good seal is provided between the housing and the hole (by virtue of the collar described above, for example), the bezel provides a good seal with the housing and the lip of the collar, and the securing ring, or retainer, urges the light generating unit and bezel into a good seal with each other.

The securing ring may be configured to rotate with respect to the formation on the bezel to secure the light generating unit to the bezel.

The light generating unit may be trapped between the bezel and the securing ring.

The securing ring, when rotated into a locked position, urges the lighting unit against the bezel to minimise the presence of gaps between the bezel and the light generating unit.

Several preferred embodiments of the invention will now be described by way of example only and with reference to the Figures in which:

### BRIEF DESCRIPTION OF FIGURES

FIG. 1 shows various views of a collar according to an embodiment of the present invention;

FIG. 2 shows various views of a light fixture housing according to an embodiment of the present invention;

FIG. 3 shows various views of a conventional light fixture along with a retrofit sleeve according to an embodiment of the present invention;

FIGS. 4A to 4F show a series of exploded views of the collar and fixture of FIGS. 1 and 2 throughout assembly, in combination;

FIGS. 5A to 5G shows a sequence of exploded views of the collar, retrofit and fixture of FIGS. 1 and 3 throughout assembly, in combination;

FIG. 6A to 6C show a rear view of part of the light fixture; and

FIG. 7 shows a tool for installing the collar into the hole.

### DETAILED DESCRIPTION OF FIGURES

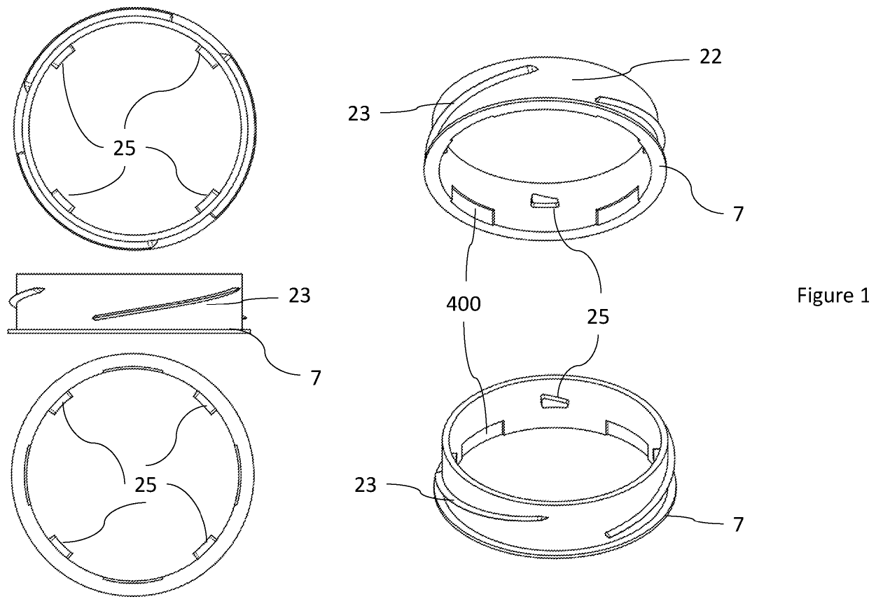

With reference to FIGS. 1 to 6 there is shown embodiments of the device generally comprising a collar 2 for a recessed fixture, in particular a recessed downlight for recessing in a hole 1, wherein the collar comprises a wall 22 to extend into the hole 1, such wall 22 comprising an external screw threading 23 for engaging with and drawing the collar 2 into the hole 1, and internal formations 25 for engaging with the recessed downlight 3 to secure the downlight 3 within the collar 2, and thus within the hole 1 in the ceiling, while permitting safe and simple removal of the downlight from the collar 2 when required.

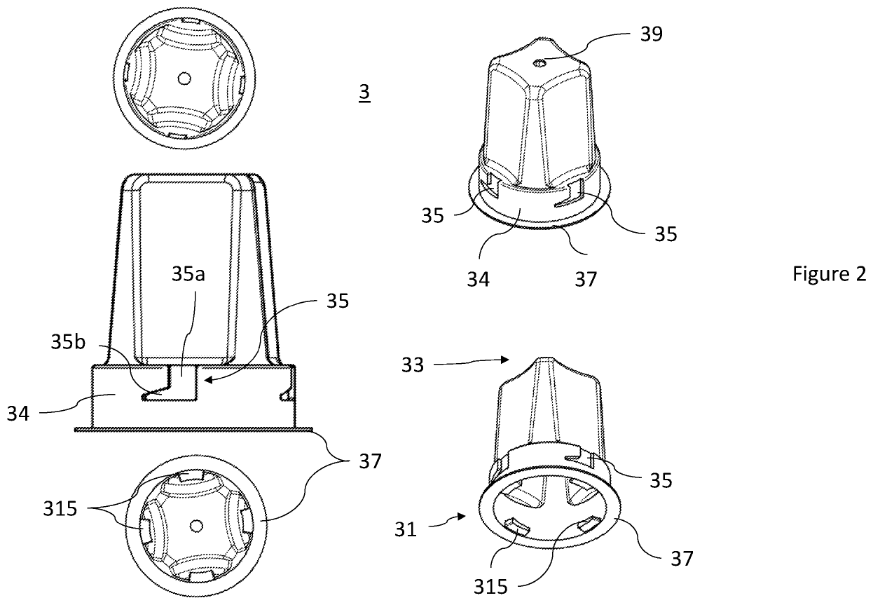

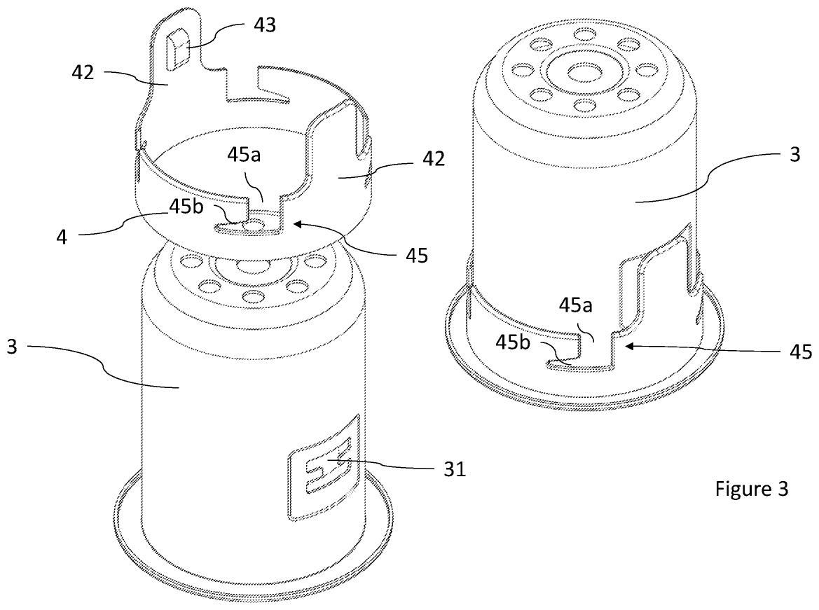

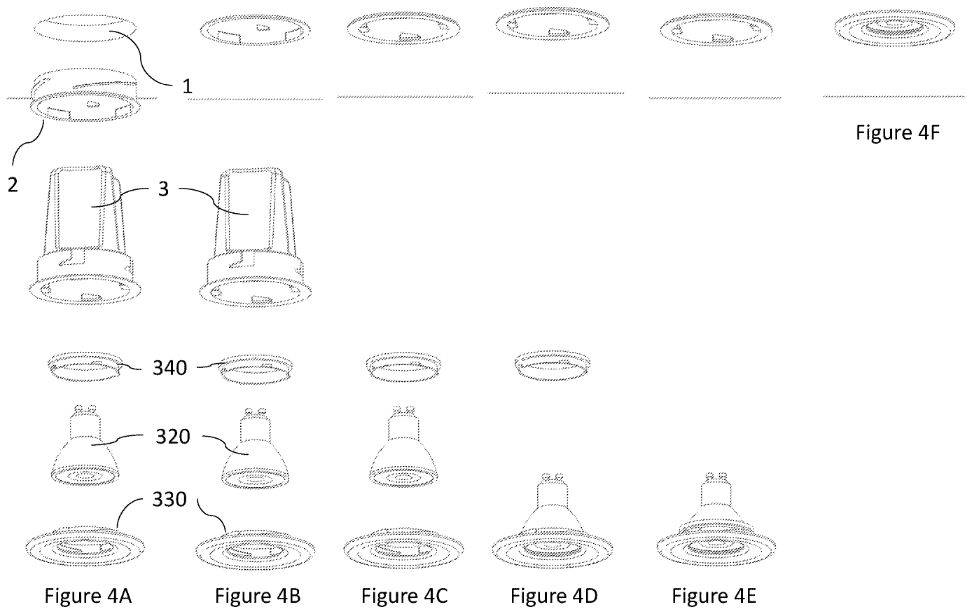

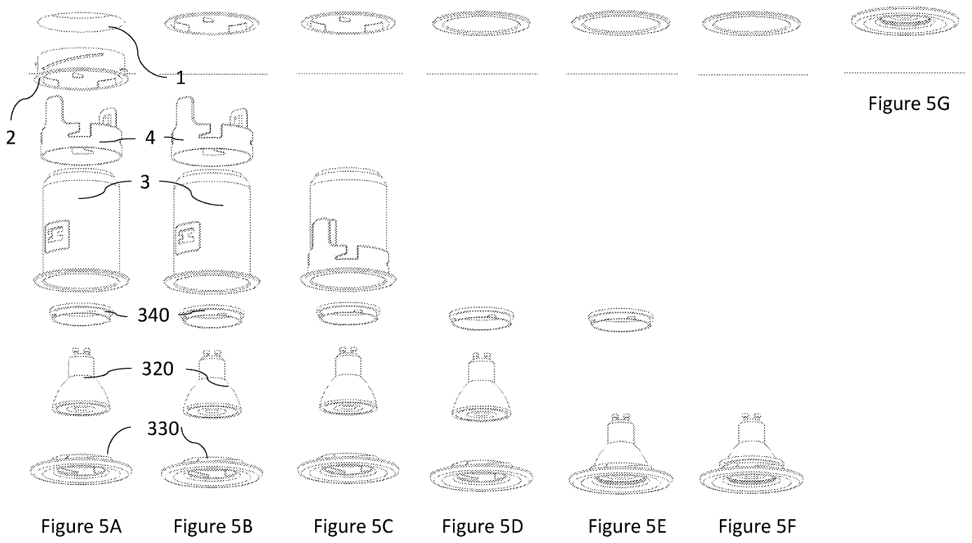

Typically, fixtures are provided with two sprung arms, at opposite sides of the fixture from each other. The present technique dispenses with these sprung arms, either by way of their removal from an existing fixture (as per FIGS. 3 and 5), or by way of the use of a new fixture which does not include sprung arms at all (as per FIGS. 2 and 4).

The collar 2 is defined generally by a cylinder or ring (annular structure) having various features, formations and structures for interacting with the hole 1 (external screw threading), the surface in which the wall is formed, formations on a housing 3 of the fixture (or on a sleeve 4 mounted on the fixture), and the body of the fixture. Significantly, the interior surface of the collar 2 comprises one or more (in this case four) internal formations 25 for engaging with one or more respective (complementary and/or correspondingly located) formations 35 of or on or in an exterior surface of the housing 3 of the fixture or one or more respective complementary formations 45 of or on or in a sleeve 4 surrounding the fixture.

The wall 22 is circular in cross section and the collar 2 comprises a laterally extending lip 7 at a first (the bottom) end of the wall. The lip 7 (which may also be referred to as a flange or rim) extends outwardly from the first end of the wall 22, one face of the lip 7 being for resting against the edges of the hole 1, the opposite face of the lip 7 generally being hidden by a bezel of the fixture. Intumescent material may be located at or on the lip 7, to create a fireproof and smokeproof seal around the edges of the hole in the event of a fire.

The formations 25 take the form of a sloped/ramped stud protruding inwardly from the (inside of the) wall 22. The formations 35 of the housing 3 take the form of a shaped channel defined in the outside of the housing 3, into which and along which the stud of the formations 25 is able to pass. At the extremity of this movement of the stud 25 along the channel 35, the stud effectively becomes (reversibly) jammed due to the shape of the stud compared with the shape of the channel 35. Similarly, in the case of a sleeve 4 being used to retrofit to an existing fixture, the formations make the form of a channel or cut-out in the sleeve 4, into which and along which the stud of the formations 25 is able to pass. As with the channel 35, at the extremity of this movement of the stud 25 along the channel 35, the stud effectively becomes (reversibly) jammed due to the shape of the stud compared with the shape of the channel 45.

In more detail, the channel 35, 45 comprises a first part 35a, 45a which has a circumferential length greater than or equal to a circumferential length of the stud 25, and which extends parallel to the longitudinal axis of the fixture 3 or collar 4. The stud 25 is intended to travel smoothly along this part 35a, 45a while the housing 3 of the fixture is received into the collar 2, until the stud 25 reaches the bottom of the channel, coincident with the fixture housing 3 being fully received within the collar 2. The channel 35, 45 also comprises a second part 35b, 45b, which extend generally at a right angle from the first part 35a, 45a. The second part 35b, 45 is sloped, similarly to the slope of the stud 25. In practice, the angle of slope of the stud 25 is slightly greater than the angle of slope of the second part 35b, 45b of the channel 35, 45. As a result, the stud 35 will become jammed in the channel 35, 45 as it moves within it, generally before reaching the end of the channel 35, 45. However, while the stud 25 will remain jammed in place throughout normal use of the fixture, it is not permanently jammed, and may be withdrawn from the channel 35, 45 by manual manipulation to rotate the fixture housing 3 with respect to the collar 2 (in an opposite direction to that which caused the studs 25 to become jammed in the channels 35, 45). More particularly, the stud 25 passes along the second part 35b, 45b of the channel into the jammed position as the fixture housing 3 is rotated in a first direction with respect to the collar 2, and is removed from the jammed position and passes along the second part 35b, 45b in the other direction (towards and into the first part 35a, 45a) when the fixture housing 3 is rotated in the opposite direction.

It will be appreciated that the channel 35, 45 is sufficiently deep (in a radial direction of the fixture 3/sleeve 4) to accept passage of the stud 25. It will also be appreciated from the Figures that four studs 25 are provided on the collar 2, and a corresponding four channels defined in or on the fixture 3 or collar 4. Fewer or greater numbers of channels could equally be provided, but at least three channels, and preferably four, provide for good stability, and a secure lock as the studs come into jamming engagement with the channels 35, 45. The collar 2 is designed to be injection moulded with a simple two-part mould, for example.

Considering the housing 3 in more detail, this is shown from various angles in FIG. 2. The housing 3 is shaped to be stackable, with multiple instances of the housing 3 being able to be stacked together to save space. This is achieved by the gently tapered shape from the housing 3, from its mouth end 31 to its back end 33. The housing 3 comprises an engagement ring 34 which in use rests proximate and within the collar 2. The engagement ring 34 is annular in shape, and bears the channels 35 (which engage with the studs 25 of the collar), a lip 37 (to abut the lip 7 of the collar 2), and the internal formations 315 for engaging the light assembly (described below). The housing 3 also comprises a body 38, extending from and away from the engagement ring 34, which has generally flattened sides. A base of the housing 3 comprises an aperture 39 though which an electrical cable may extend to connect the light fixture to a power supply (not shown).

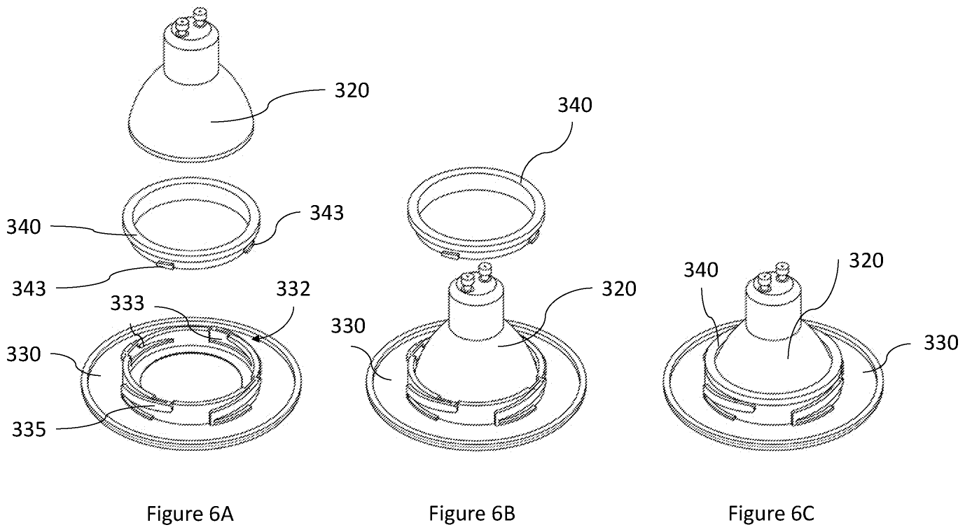

The fixture comprises several parts in addition to the housing 3, as can be seen from FIGS. 6A to 6C. In particular, the fixture comprises, in addition to the housing 3, an illumination unit 320, a bezel 330 and a retainer 340. When fully installed only the bezel 330 and part of the front of the illumination device 320 is visible (as can be seen from FIGS. 4F and 5G, showing fully installed states of the fixture), with the bezel 330 covering other parts of the fixture, and well as hiding the collar 2. The inside of the bezel 330 comprises a circular (or optionally part-circular) wall 332 sized to snugly receive a front part of the illumination unit 320. It can be seen that the wall 332 has internal formations 333 in the form of a two part channel of similar form to the channels 35, 45 in the housing 3 or sleeve 4, for engagement with external formations 343, for example a sloped stud of a similar form to the stud 25. Four channels 444 may be provided on the wall 332 of the bezel 330, for engagement by a respective four studs 343. However, in an alternative implementation, screw threading could be used, or any other suitable form of mutual engagement. More generally, the internal formations 333 are shaped and dimensioned to engage with external formations 343 on the retainer 340.

The wall 332 further comprises external formations (for example screw threading) 335. The external formations 335 are shaped and dimensioned to engage with internal formations 315 on (and in particular proximate the mouth of) the housing 310. In other words, the retainer 340 secures the illumination unit 320 to the bezel 330, while the bezel is secured directly to the housing 310 via the external formations 335 on the wall surrounding the illumination unit 320.

The assembly process of the illumination unit 320, bezel 330 and retainer 340 can be readily understood from the progression shown through FIGS. 6A to 6C. In particular, in FIG. 6A the illumination unit 320, bezel 330 and retainer 340 are shown separately (exploded view). In FIG. 6B, the illumination unit 320 is shown received within the circular wall 332 of the bezel 330, with the retainer 340 remaining separate. In FIG. 6C, the retainer 340 has been screwed down onto (and within) the wall 332 (using the formations 333 and 343), to secure the illumination device 320 between the retainer 340 and the bezel 330. This assembled unit can then being inserted into the housing 3, as will be explained below.

Before considering assembly further, the retrofit option for an existing fixture will first be discussed, by referring to FIGS. 3A and 3B. Here, a conventional housing 3 along with a generally annular retrofit sleeve/4 can be seen. FIG. 3A shows the sleeve 4 separately from the fixture 3, while FIG. 3B shows the sleeve 4 mounted onto the fixture 3. The conventional housing 3 has had sprung arms (not shown) removed, leaving behind formations (apertures) 31 (one on each side, but only one of which is visible in FIG. 3) via which the sprung arms were previously attached to the housing 3. The sleeve 4 comprises a pair of arms 42, which extend away from the main, annular, part of the sleeve 4, and which have, on their inside surfaces a protrusion (formation) 43 shaped and dimensioned to engage with the apertures 31 of the fixture. In use, the sleeve 4 is slid over the fixture housing 3 (from the rear of the fixture 3, as shown), and the protrusions 43 aligned with, and permitted to engage with, the apertures 31, thereby locking the fixture 3 and the sleeve 4 together, as shown in FIG. 3B. As can be seen, this locates the sleeve substantially at the front portion of the fixture 3, and sets the position of the channel 45 to the correct position to engage with the stud 25 of the collar 2, as discussed above.

It will be appreciated that, while in the present examples a stud (protrusion) 25 is provided on the collar 2, and a channel or groove 35, 45 provided on the sleeve 4 or fixture housing 3, this could be reversed if preferred.

FIGS. 4A to 4F illustrate the various installation stages of the first embodiment (based on FIGS. 1 and 2). In FIG. 4A, the parts are all separate, and a hole 1 is provided in the ceiling. In FIG. 4B, the collar 2 has been inserted into the hole 1, and rotated so that the screw threading on the exterior of the collar 2 pulls the collar 2 firmly into engagement with the ceiling. The lip 7 of the collar pushes against the ceiling, preventing it from moving further, and creating a tight fireproof seal. The external screw threads shown in the figures comprise three integral helical screw threads providing a means to anchor the collar 2 to the material thorough which it is inserted. The integral screw threads also have a sharp leading edge, thereby providing a way of cutting into the material though which the collar is inserted during installation. As will be explained subsequently, a dedicated tool may be used to rotate the collar into engagement with the hole-although it will be appreciated that it may instead be screwed in by hand. In FIG. 4C, the housing 3 of the fixture, which bears the channels 35, is inserted into the collar 2, and rotated so that the studs 25 of the collar 2 engage the channels 35, and pull the fixture housing 3 into close engagement with the collar 2 and thus the hole 1. In FIG. 4D, the illumination unit 320 is placed into and against the bezel 330, and then in FIG. 4E is trapped in place against the bezel 330 by the retainer 340. To achieve this, the retainer 340 is screwed down over a portion of the illumination unit 320, by way of the formations 333, 343 as discussed above. The assembled illumination unit 320, bezel 330 and retainer 340 are then inserted into the housing 310 and rotated with respect thereto to secure the fixture together, relying on the formations 335, 315, as shown in FIG. 4F. The above stages can be reversed to remove and disassemble the light unit.

FIGS. 5A to 5G illustrate the various installation stages of the second (retrofit) embodiment (based on FIGS. 1 and 3). In FIG. 5A, the parts are all separate, and a hole 1 is provided in the ceiling. In FIG. 5B, the collar 2 has been inserted into the hole 1, and rotated so that the screw threading thereof pulls the collar firmly into engagement with the ceiling. In FIG. 5C, the sleeve 4 has been pushed over and onto the fixture 3, to engage with the holes left behind by removal of the sprung arms. In FIG. 5D, the fixture housing 3 and sleeve 4, (the latter bearing the channels 45), are inserted into the collar, and rotated so that the studs 25 of the collar engage the channels 45, and pull the fixture housing and sleeve into close engagement with the collar 2 and the hole 1. In FIG. 5E, the illumination unit 320 is placed into the bezel 330, and then in FIG. 5F is trapped in place against the bezel 330 by the retainer 340. To achieve this, the retainer 340 is screwed down over a portion of the illumination unit 320, by way of the formations 333, 343. The assembled illumination unit 320, bezel 330 and retainer 340 are then inserted into the fixture housing 3 and rotated with respect thereto to secure the fixture together, relying on the formations 335, 315, as shown in FIG. 5G. The above stages can be reversed to remove and disassemble the light unit.

With the above installation, the external screw threading on the collar 2 bites into the edges of the hole and draws the collar 2 fully into the hole, so that a lip of the collar 2 is substantially flush with the ceiling. The laterally extending lip 7 may have a coating of intumescent paint or a gasket of Intumescent material added. In the event of fire the intumescent expands and seals the gap between the collar 2 and the downlight bezel stopping fire, smoke and gasses from being able to get access to the aperture and subsequently spreading between floors via the ceiling/wall/floor cavity. This provides a fire resistant seal, with no gaps. The collar may be moulded plastic such as polyethylene or acrylonitrile butadiene styrene (ABS) and/or intumescent material and may be envisaged to be flexible in nature. Preferably, the collar is formed from a VO fireproof material or equivalent.

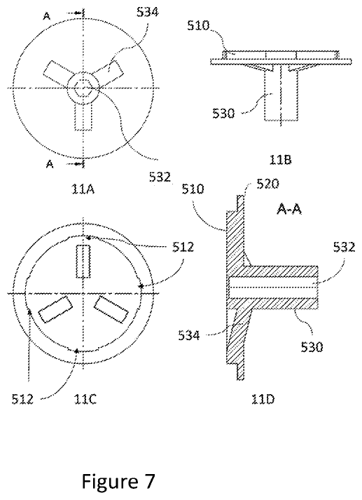

In order to permit the use of a dedicated tool for installing the collar 2 into the hole 1, the collar 2 is provided with tool engagement slots/recesses 400 on the inside surface of one end of the wall (the end at which the lip 7 is formed) to engage with corresponding formations of the tool. The engagement slots 400 may be cutouts, indents or other concave formations defined in the inner surface of the wall. FIG. 7 shows an example of a tool 500 suitable for this purpose. It will be appreciated that the tool engagement slots 400 on the collar provide a structure by which the installation tool, with corresponding protuberances matching the same geometry as the tooling engagement slots can engage with the collar 2 in order for it to be installed. Four engagement slots are provided in the present example, equally disposed around the inside surface of the wall proximate its first (lip) end. As such, the tool uses four protuberances, one for each of the engagement slots 400.

Referring to FIG. 7, the tool 500 can be seen to comprise a collar engagement plate 510, a peripheral rim 520 and a central drive stem 530. The central drive stem 530 comprises a hexagonal internal bore 532 for receiving a drive shaft, such as a hexibar or dedicated power drill extension. The drive shaft is driven to rotate either by hand or motor torque, and this drives rotation of the tool 500. The tool 500 can be driven in a first direction (for example clockwise) to screw the collar into/onto the hole, and in a second direction (for example anticlockwise to unscrew and remove the collar from the hole.

A plurality (in this case three) of reinforcement struts 534 are provided to ensure that the central drive stem 530 does not shear away when the drive shaft is rotated therein. The collar engagement plate is generally circular, but comprises a series of (in this case four, but other numbers are also viable) protuberances 512, disposed around the periphery of the plate and extending outwardly (radially), which are shaped and dimensioned to engage with the tooling engagement slots in the collar. Note the four protuberances 512, two (opposing ones) for engagement with the engagement slots 400 and two (opposing ones) for engagement with part of the channels 103. It will be appreciated that, in use, the collar engagement plate 510 is inserted into the first end of the collar 199 with the protuberances 512 being received in the tooling slots. The rim 520 is brought to rest against the first end of the collar (the lip 7) such that the collar engagement plate 510 is fully received and is less likely to jump out of the collar upon rotation thereof. However, in order to avoid damage to the collar and/or the ceiling and/or the tool, the rim 520 only permits the collar engagement plate 510 to extend a controlled distance (in the present example 5 mm), such that if the applied torque exceeds a predetermined threshold, the collar engagement plate 510 will jump out of the collar. In alternative embodiments, the rim 520 may not be required, with control of the depth of the tool into the collar being achieved by the limited depth of the engagement slots 400.

It should be understood that the slots on the collar 2 and the protuberances on the tool 500 may be reversed, although this is less preferred due to the risk of protuberances inside the collar 2 fouling on parts of a light fixture.

Overall, the present technique provides an improved seal around the hole into which the downlighter is installed, thereby reducing the likelihood of smoke passing through the hole in the event of a fire (noting that the fixture itself will generally be provided with intumescent parts to create a seal within the fixture). The screw threading provides a tight seal, due to the screw threading engaging with the material of the ceiling, and the ability to provide the collar as a tighter fit within the hole due to the fact that it is not intended to be removed with the fixture. Furthermore, the light fixture assembly, and in particular the housing 3 (which is closely engaged with the collar), the bezel 330 (which is closely engaged with the housing 3), and the illumination unit 320 (which is closely engaged with the bezel 330, via the retainer 340) are all constructed to minimise gaps through which smoke and fire may pass.

The invention has been described by way of examples only and it will be appreciated that variation may be made to the above-mentioned embodiments without departing from the scope of invention as defined by the claims, in particular but not solely combination of features of described embodiments.

1. A fitting system for a recessed fixture, in particular a recessed fixture for recessing in a hole, wherein the fitting system comprises a collar having a wall to extend into the hole, such wall comprising an external formation for engaging with the hole, and one or more internal formations for engaging with one or more respective formations on an exterior surface of the fixture or of a sleeve surrounding the fixture.

2. A fitting system according to claim 1, comprising a sleeve for surrounding the fixture, the sleeve comprising the formations, and one or more further formations for engaging with the fixture.

3. A fitting system according to claim 2, wherein the further complementary formations are shaped and dimensioned to engage with openings in the casing of the fixture from which sprung arms have been removed.

4. A fitting system according to claim 3, wherein the further complementary formations are positioned on the sleeve such that the collar is retained proximate a light emitting end of the fixture.

5. A fitting system according to claim 1, wherein the fixture comprises a housing having an external surface bearing the complementary formations, wherein a plurality of such complementary formations are provided.

6. A fitting system according to claim 1, wherein the internal formations comprise protrusions, and the complementary formations comprise channels for receiving the protrusions.

7. A fitting system according to claim 6, wherein the channels each comprise a first channel part extending from one end of the wall for receiving the protrusions as the fixture is inserted into the collar, and a second channel part extending at an angle to the first channel part, along which the protrusions pass as the fixture is secured into the collar.

8. A fitting system according to claim 7, wherein the protrusions are ramp shaped, the ramp shape being generally complementary in shape with at least an end portion of the second channel part.

9. A fitting system according to claim 8, wherein a slope angle of the ramp shape is greater than a slope angle of the generally complementary end portion of the second channel part.

10. A fitting system according to claim 6, wherein the internal formations of the collar and the respective complementary formations are configured to permit the internal and complementary formations to be fully engaged with each other by rotation of the fixture and the collar with respect to each other.

11. A fitting system according to 1, wherein the external formation of the wall comprises screw threading for screwing the collar into the hole.

12. A fitting system according to claim 11, wherein a direction of rotation of the collar to screw it into the hole and a direction of rotation of the fixture to secure it into the collar are the same.

13. A fitting system according to claim 1, wherein the collar comprises a lip extending from the bottom edge of the wall.

14. A fitting system according to claim 1, wherein the collar comprises intumescent material.

15. (canceled)

16. A fitting system according to claim 1, comprising one or more engagement formations for engaging with a tool.

17. (canceled)

18. A fitting system according to claim 1, wherein the external formation of the wall comprises ridges for engaging with the hole, and wherein the collar comprises an inner part and an outer part, wherein the outer part bears the ridges and is formed of a more flexible material than the inner part.

19. A fitting system according to claim 18, wherein the inner part and outer part are provided with mutually engaging formations to secure them together.

20. A fitting system according to claim 1, comprising the fixture.

21. A method of fitting a recessed fixture into a hole, comprising inserting a collar having a wall into the hole, such that the wall enters the hole, inserting the collar into the hole such that an external formation on the wall engages with the hole, and inserting a fixture into the collar, such that one or more internal formations on the inside of the wall engage with one or more respective complementary formations on an exterior surface of the fixture or of a sleeve surrounding the fixture.

22. (canceled)

23. A lighting assembly, comprising:
a housing;
a light generating unit;
a bezel; and
a securing ring;
wherein the bezel is securable to one end of the housing and the light generating unit is securable to the inside of the bezel; and
wherein the inside of the bezel comprises a formation for receiving the light generating unit, and the securing ring is configured to be mounted to the formation to secure the light generating unit to the bezel.

24. (canceled)

25. (canceled)

26. (canceled)
